(19) United States
(12) Patent Application Publication
(10) Pub. No.: US 2017/0104633 A1
(43) Pub. Date: Apr. 13, 2017

(54) WIFI GATEWAY CONTROL AND INTERFACE

(71) Applicant: Startimes Communication Network Technology Co., Ltd., Beijing (CN)

(72) Inventors: Jiangtao Wen, Los Angeles, CA (US); Yi Pang, Beijing (CN); Zhenyu Wang, Beijing (CN); Sijie Zeng, Beijing (CN); Hongwei Yao, Beijing (CN); Youle Hu, Beijing (CN); Qian Hu, Beijing (CN); Xi Wu, Beijing (CN); Yao Lu, La Jolla, CA (US)

(73) Assignee: Startimes Communication Network Technology Co., Ltd., Beijing (CN)

(21) Appl. No.: 15/314,250

(22) PCT Filed: May 29, 2015
(86) PCT No.: PCT/IB2015/054091

§ 371 Date: Nov. 28, 2016

Related U.S. Application Data
(60) Provisional application No. 62/004,431, filed on May 29, 2014.

(51) Int. Cl. H04L 12/24; H04L 12/725; H04W 24/02; H04L 12/26

(52) U.S. Cl. CPC H04L 41/0886; H04L 43/062; H04L 41/0896; H04L 45/302; H04W 24/02; H04W 84/12

(57) ABSTRACT

A wireless network gateway may include monitoring and analysis functionality for automatically configuring the network gateway's connection characteristics based on an analysis of monitored network traffic.

### TECHNICAL FIELD

The current disclosure relates to controlling network access and in particular to providing a WiFi Gateway capable of monitoring and controlling network access and traffic.

### BACKGROUND

Wireless networks connect a number of different devices to the Internet. For example, in a home environment, a gateway, such as a wireless access point or router, can connect devices to the internet, including phones, tablets, computers, televisions, as well as other devices such as security systems, hvac systems, smart appliances, networked cameras and other sensors and controllers etc. Although referred to as a wireless access point of gateway, the connections may include wired connections to one or more devices.

As more devices are connected to the Internet in a home or small business environment, it may be desirable to provide a system for easily monitoring and network access.

### SUMMARY

In accordance with the present disclosure there is provide a wireless network gateway comprising a plurality of network interfaces for connecting to a plurality of communication devices; routing functionality for routing network traffic between the network interfaces, the routing functionality including bandwidth control functionality for controlling network traffic associated with one or more of the connected communication devices; monitoring functionality for logging traffic flow information associated with a plurality of the communication devices; analysis functionality for processing logged traffic flow information to identify activities associated with the logged information; and auto configuration functionality for setting bandwidth control characteristics based on identified activities.

In an embodiment of the wireless network gateway, the bandwidth control characteristics specify an amount of bandwidth allocated to a particular one of the communication devices.

In an embodiment of the wireless network gateway, the bandwidth control characteristics are associated with a device or group of devices and determined based on a sole communication device's determined activities or activities of communication devices associated with the device group.

In an embodiment of the wireless network gateway, the auto configuration functionality further configures traffic filter settings for filtering network traffic of the device.

In an embodiment of the wireless network gateway, the analysis functionality is at least partially performed at a network connected server.

In an embodiment of the wireless network gateway, the logged information includes bandwidth usage information associated with a device or device group.

In an embodiment of the wireless network gateway, the logged information further comprises one or more of application information, source information, and destination information.

In an embodiment of the wireless network gateway, the bandwidth control characteristics are specified at scheduled times.

In an embodiment of the wireless network gateway, the wireless network gateway further comprises user interface functionality for providing an interface for interacting with the wireless network gateway.

In an embodiment of the wireless network gateway, the plurality of communication devices are grouped together into a plurality of device groups.

In accordance with the present disclosure there is further provided a method for configuring wireless network gateway comprising a plurality of network interfaces for connecting to a plurality of communication devices, the method comprising: routing network traffic between the network interfaces in accordance with bandwidth control functionality for controlling network traffic associated with one or more of the connected communication devices; logging traffic flow information associated with a plurality of the communication devices; processing logged traffic flow information to identify activities associated with the logged information; and setting bandwidth control characteristics based on identified activities.

In an embodiment of the method, the bandwidth control characteristics specify an amount of bandwidth allocated to a particular one of the communication devices.

In an embodiment of the method, the bandwidth control characteristics are associated with a device or group of devices and determined based on a sole communication device's determined activities or activities of communication devices associated with the device group.

In an embodiment of the method, the method further comprises configuring traffic filter settings for filtering network traffic of the device.

In an embodiment of the method, the processing of logged traffic flow information is at least partially performed at a network connected server.

In an embodiment of the method, the logged information includes bandwidth usage information associated with a device or device group.

In an embodiment of the method, the logged information further comprises one or more of application information, source information, and destination information.

In an embodiment of the method, the bandwidth control characteristics are specified at scheduled times.

In an embodiment of the method, the method further comprises providing an interface for interacting with the wireless network gateway.

In an embodiment of the method, the plurality of communication devices are grouped together into a plurality of device groups.

### BRIEF DESCRIPTION OF THE DRAWINGS

Features, aspects and advantages of the present disclosure will become better understood with regard to the following description and accompanying drawings in which:

FIG. 1 depicts a WiFi gateway;

FIG. 2 depicts details of a WiFi gateway;

FIG. 3 depicts device configurations for the WiFi gateway;

FIG. 4 depicts a method for automatically configuring WiFi gateway settings;

FIG. 5 depicts a method for monitoring WiFi gateway traffic;

FIG. 6 depicts a method of analyzing the monitoring data;

FIG. 7 depicts a method of processing device usage patterns; and

FIG. 8 depicts a method for determining WiFi gateway bandwidth settings.

### DETAILED DESCRIPTION

In home environments, home office environments, small office environments and other similar environments, a common gateway is often used to provide a plurality of devices access to each other, as well as other networks such as the Internet. The gateway may be configured to control access and network traffic flow based on various settings. For example, the gateway may be manually configured, either directly or using one or more wizards or setup processes, to prioritize certain types of traffic over other types of traffic, limit traffic from particular devices, prevent certain devices from accessing particular sites as well as well as control traffic based on a time of the day. Although the gateway may be manually configured to control traffic flow of connected devices, as described further, the gateway may automatically configure the settings based on observed traffic.

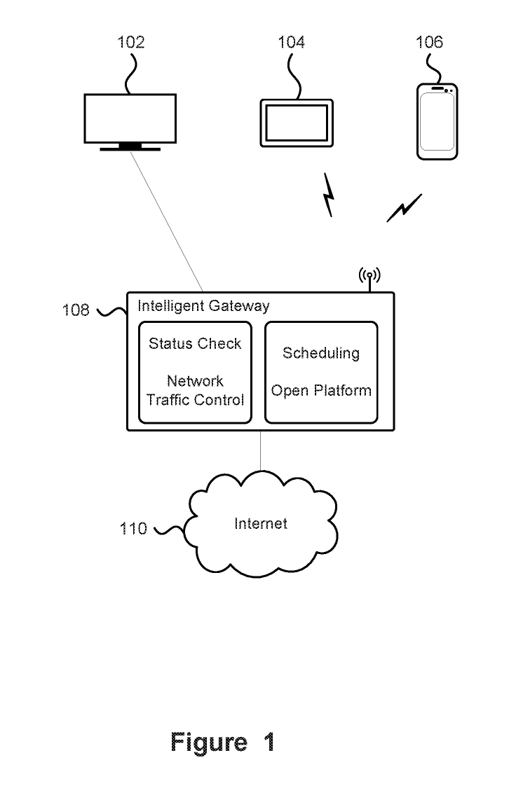

As depicted in FIG. 1 a number of devices, such as televisions 102, tablets 104 and phones 106 may connect to an intelligent gateway 108. The intelligent gateway 108 may include WiFi access point, switch or router functionality in order to allow the connected devices to communicate with each other as well as other connected networks such as the internet. The connections to the devices may either be wired or wireless. Although not specifically depicted in FIG. 1, a number of other types of devices may be connected, including for example smart home appliances or controls including thermostats, alarm systems, monitoring systems, weather systems, etc. Further devices may include personal computers, laptops etc.

The intelligent gateway 108 may include various functionality including, for example status check or monitoring functionality for monitoring for example device bandwidth usage as well as detailed usage information such as application types being used and network sites or services being accessed. The intelligent gateway may further include network traffic control functionality that controls connection characteristics of the devices. These connection characteristics may include, for example whether or not the device can connect to the Internet, what priority the device's traffic, how much bandwidth is allocated or reserved for the device as well as whether or not the device can access specific websites or network locations, including both internal and external network locations. The intelligent gateway may also include scheduling functionality, which may be used to control connection characteristics, such as those described above, based on a particular schedule. As an example, a parent may block a child's device from accessing Netflix, or other video services, on weeknights after 9:00 pm. The intelligent gateway may be an open platform that allows third party developers to develop additional functionalities and plug-ins for the router. The open platform may be provided as documented application programming interfaces (APIs) that can be used by developers to access the gateway functionalities.

The system 100 may provide network connection to devices through an authenticated, secure and easy-to-use interface. Further an administrator may control, in fine granularity, access to the network by devices through the gateway. One or more of the devices connected to intelligent gateway 108 may be used as a control and configuration device that provides a user interface for controlling and configuring the gateway. The configuration device may be provided, for example, by an application running on a wireless device, such as a tablet or phone. The system provides device detection and registration. When a device is connected to the network controlled by the gateway 108, it will be identified automatically by the gateway using a unique ID (e.g. The MAC address). An administrator could download the control application automatically, for example by scanning a QR code with a mobile device and then logging on to the gateway. A privileged administrator account may be created, which may be controlled by a password and/or other means of authentication, such as being accessed from a specific device, which may be termed an “Administrator Device”.

The control logic and the user interface may be run on the gateway or an application software on the Administrator Device. When the user interface is run on the gateway, the user interface may be transmitted over a communication channel, such as the wired and/or wireless network provided by the gateway, to the Administrator Device.

Once configured, the Administrator Device can present a user interface that allows the configuration of the intelligent gateway. The intelligent gateway can control the access of any of the devices on the network to other connected devices as well as to the broad internet. For example, for each device, or groups of devices, the intelligent gateway may control one or more of:
A total amount of data sent and/or received per time period, such as hour, day, week, month or a user specified time period;
An ability to access, or block access, the internet based on time;
An ability to access, or block access to, particular websites based on specified lists, such as white lists for allowing access to sites or black lists for block access to sites which are undesirable or unsafe;
An ability to access, or block access to, the internet based on an application, such as Email vs. web browsing vs. gaming etc.;
A throughput and/or profile of throughputs for different sites as a function of time and other information;
A throughput and/or profile of throughputs for different applications;
Provision of an exclusive network that allows a connected device access to the network with priority;
Provision of a guest mode allowing guest users to connect to the network without a password, possibly during specified time periods;
Start up/Shut down at specified time periods; and
Signal intensity regulation to regulate the Wifi signal intensity according to the network coverage and possibly the position of the device

The controlling of gateway characteristics described above, may be adjusted to change the connection characteristics associated with individual devices or groups of devices. The adjusting of connection settings may be triggered in many ways. The triggers may include one or more of:
The gateway based on network traffic;
Information determined from emails, SMS, calendar, web browsing etc.;
Time of day/year; and
Time of day, network load and service type.

Further the network connection characteristics of one or more of the devices connected to the network gateway may be controlled. For example, the ability to access or block access to the internet based on time, bandwidth, websites accessed or applications used, may be controlled manually or as described further below automatically, using various user modes. For example, a child-sleeping mode may block internet access for a device associated with a child after 9 p.m. Further, a guest mode may control access of devices associated with a guest user in order to prevent applications that typically consume large amounts of bandwidth from accessing the internet. The gateway may be placed in one or more user modes either manually, or based on other factors such as time of day. The user modes may include, for example, night mode, outdoor mode, entertainment mode, and anti-theft mode, healthy modes such as the baby mode, pregnancy mode, as well as parental management including a parent mode, study mode, sleep mode, holiday mode and etc. Each of the different modes may define network connection characteristics of different devices or device groups to apply to traffic to our from the devices.

The gateway may provide monitoring functionality, including virtual time machine functionality that allows viewing connection activities of users. A special privileged user, such as a user of an Administrator Device can monitor, either in real time or after-the-fact, activities related to network access on monitored devices, including for example signal intensity, websites visited, information received, real-time throughput, access duration, etc. The administrator may view the information in order to help with manually configuring network functionality.

In addition to controlling connection characteristics associated with individual devices, users, or rather user devices connected to the intelligent gateway, may be categorized into different groups, such as parents, kids, friends, guests, business, smart appliance or administrator defined groups. The categorization of the devices may be done manually for example by an administrator specifying device groups for particular devices. With all the network traffic flow information of devices or device groups gathered, the traffic of users or rather the associated device groups can be analyzed by the gateway and/or a server in the cloud to determine usage patterns to better and/or automatically adjust gateway settings to optimize or improve a user experience and network performance. A model of the usage patterns of the devices may be generated based on the analyzed traffic flows in order to determine network characteristics for applying to devices. As an example, if upon analyzing the traffic flow, it is determined that none of the connected devices access the internet or other devices between 2:00 am and 6:00 am, the gateway may be configured to enter a low power sleep mode. In addition to automatically configuring the gateway based on monitored traffic patterns, the gateway may further adjust connection characteristics based on real-time or near real-time information such automatically lowering transmission power when a user gets close in order to reduce power consumption and/or reduce radiation, while still satisfying the user bandwidth and other requirements. Further, if wireless devices are disconnected from the gateway during periods when it is determined that the device does not use the network, the gateway may provide an improved RF environment for other devices.

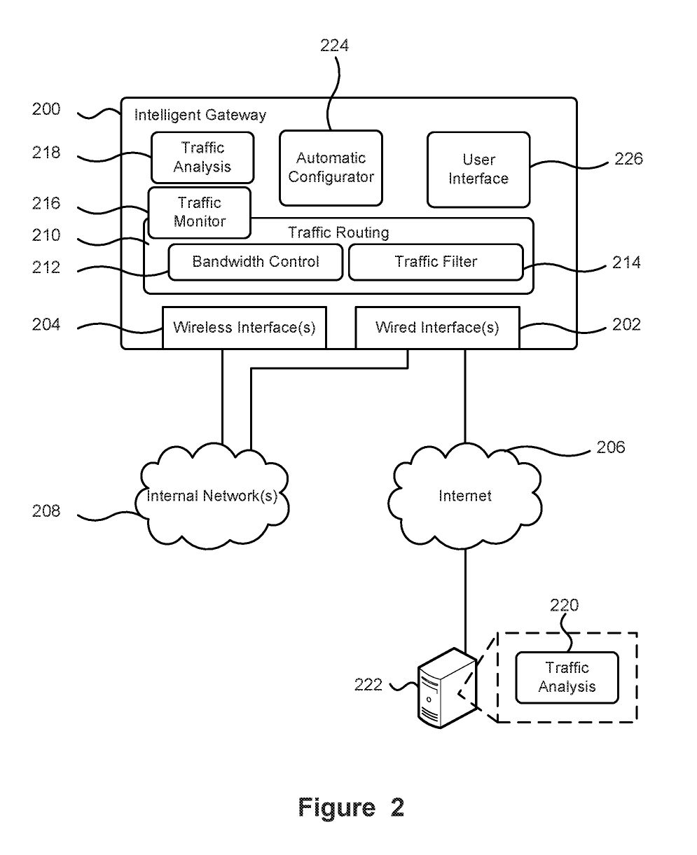

FIG. 2 depicts details of an intelligent WiFi gateway. The gateway 200 may include one or more wired interfaces 202 as well as one or more wireless interfaces 204 for connecting the gateway 200 to one or more networks. As depicted, the gateway 200 may be connected to an external network such as the internet 206. The connection to the internet may be provided by a modem or other similar termination device, although the intelligent gateway 200 may incorporate the modem or other communication functionality required for connecting to external networks such as the internet 206. Additionally, the gateway 200 may connect to, or provide, one or more internal networks 208 to which devices can connect. The internal networks 208 may be provided by the wireless interfaces 204 and/or by the wired interfaces. The gateway 200 further includes traffic routing functionality 210 for routing traffic between the interfaces and devices connected to the interfaces. The traffic routing functionality 210 may include bandwidth control functionality 212 that can control bandwidth used by individual devices. For example, the bandwidth control functionality 212 may be used to limit an amount of bandwidth used by a particular device. The bandwidth control functionality 212 may be used to provide quality of service routing of traffic which may preferentially route network traffic based on a priority of the traffic. Further, the bandwidth control functionality may be used to reserve or allocate bandwidth to devices. The configuration of the bandwidth control functionality may be configured manually or automatically. Further, the configuration may be specified either statically, or using a schedule so that the configuration changes based on a time of day and/or day of the week etc. For example, if the gateway is used in a home office environment, it may be configured to allocate 90%, or some other value, of the available bandwidth to devices identified as business devices during the work day, while outside of regular work hours no specific bandwidth amount is dedicated to business devices.

In addition to the bandwidth control functionality 212, the gateway 200 may further include traffic filter functionality 214 for filtering network traffic of connected devices. The filtering functionality 214 may be configured to block access to particular websites or services. For example, various lists are available that categorize websites based on content and/or security threats. The access to sites on one or more lists, often referred to as black lists, may be blocked. Further, the filter functionality may be configured to block devices from accessing other network resources. As an example, traffic from devices identified as guest devices may be filtered in order to prevent the guest devices from accessing other devices on the internal network while still allowing access to the Internet, which may also be filtered according to lists. As with the bandwidth control functionality 212, the traffic filter functionality 214 configuration may be static or may be specified according to a schedule. As an example, devices associated with children may have the associated traffic filtered in order to only allow access to certain sites such as Youtube or Facebook during particular times of the day such as 7:00 pm-8:00 pm.

The gateway may further comprise traffic monitoring functionality 216. The traffic monitoring functionality 216 may monitor traffic flows from one or more of the devices connected to the gateway. The monitoring may log various information about traffic flows from the monitored devices. The traffic monitoring functionality 216 may store the monitoring data for subsequent analysis, and/or review. The monitoring data may be stored for a set period of time, for example the past day, week or month or the amount of monitoring data able to be stored may be specified.

The gateway 200 may include traffic analysis functionality 218 for analyzing the monitored data and generate a device usage model of the monitored devices. Although the traffic analysis is described as being applied to the monitored traffic flow data of individual devices, the monitored data may be aggregated based on device groups and the analysis carried out across the monitored devices of a particular group. The traffic analysis may attempt to classify monitored traffic as one of a plurality of defined activities. For example, a traffic flow for a device may be classified as a watching a video, reading websites, listening to music, VoIP calls, etc. The level of classification, or the accuracy of the classification of traffic flows may depend upon the level of detailed logged by the monitoring functionality for the traffic. For example, if the monitoring functionality only logs an amount of data sent and/or received at specific times, it may only be able to classify the activities broadly, such as streaming a movie, which would have a relatively long period of high download bandwidth consumption and relatively low upload bandwidth consumption, or as reading websites, which may have a lower download to upload ratio and be relatively bursty. If the monitoring functionality logs more detailed information, such as an application associated with the traffic as well as a network address or website of the traffic, finer classification and/or a classification with a higher degree of accuracy may be provided. For example, rather than simply classifying traffic as ‘streaming movies/videos’, it could be possible to classify the traffic as streaming Netflix videos or streaming Youtube videos.

In addition to the traffic analysis for classifying network activities, the traffic analysis functionality 218 may also attempt to classify or identify devices on the network. For example, smart home devices or appliances may be identified based on the network traffic or a fingerprint of the network traffic and the identification used to further configure or adjust the gateway. As an example, a home device such as a smart thermostat may be identified based on an analysis of the traffic and identified as such in user interfaces to simplify administration. Further, the network connection configurations could be adjusted based on the identified device type. The thermostat or other devices may be identified based on unique characteristics, or a unique collection of non-unique characteristic, of the network traffic. That is, a device may have particular network transmission characteristics, such as information contained in network headers, when communication occurs, what sites the device communicates with etc, which may uniquely identify the device.

The traffic analysis functionality 218 is described as being part of the gateway 200. Additionally, the traffic analysis, or a portion of the traffic analysis 220, may be performed at a server or other Internet connected device 222. For example, the gateway may transmit monitoring data, which could possibly be compressed, to the traffic analysis functionality 220 at the server 222. The traffic analysis 220 at the server may benefit from more computing resources as well as access to greater amounts of information, such as network traffic from other gateways. The traffic analysis results, which could be for example device identification, activity classifications and/or device usage models may be returned to the gateway 200 and used as if they were determined at the gateway 200 itself.

The gateway 200 may further comprise automatic configuration functionality 224 for configuring the connection characteristics of the gateway. The automatic configuration functionality 224 may use the device usage models in order to determine connection characteristics that would improve the user experience of those using the gateway. For example, the automatic configuration functionality 224 may configure an allotted bandwidth to a device that during a time period when it normally streams movies. That is, if the device model indicates that a device streams movies between 8:00 pm and 11:00 pm, an appropriate amount or portion of available bandwidth may be allocated to the device. The automatic configuration may place the device in sleep states, or may disconnect devices during periods when no activity occurs. The gateway may further comprise user interface functionality 226 for presenting a user interface to a user. The user interface may allow the gateway settings and information to be viewed and altered by a user.

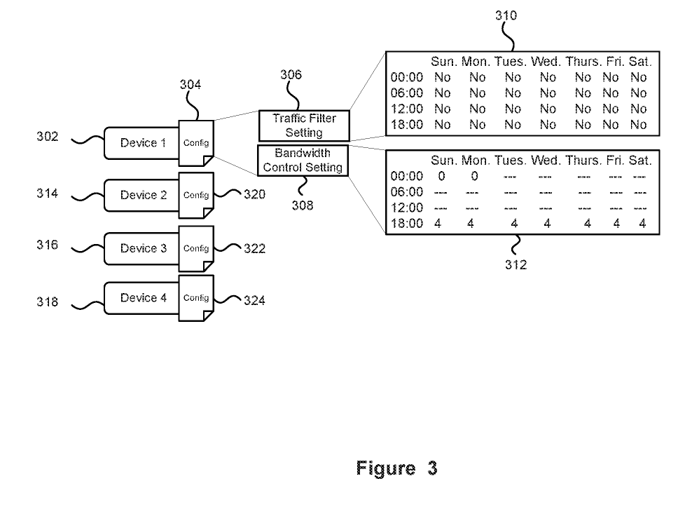

FIG. 3 depicts device configurations for the WiFi gateway. As depicted, a number of devices 302, 314, 316, 318 that are connected to the gateway, and which may be uniquely identified for example by a media access control (MAC) address, may each be associated with configurations 304, 320, 322, 324. Although depicted as being associated with individual devices, the configurations may be associated with multiple devices. Additionally or alternatively, one or more configurations may be associated with groups of devices. Each of the configurations may specify one or more settings for controlling connection characteristics of the gateway for the associated device or devices. As depicted the configuration associated with one of the devices 302 includes traffic filter settings 306 and bandwidth control settings 308. The traffic filter settings 306 may specify one or more filtering rules to apply to the device traffic. The settings may be specified for a schedule 310. As depicted filtering rules are specified for every 6 hour period throughout a week. The schedule 310 indicates that no traffic filtering is to be applied to the device's traffic. Rather than indicating that no traffic filtering should be applied, the schedule may indicate particular rules or filter lists to apply. Further, although depicted as being specified at 6 hour intervals, it is contemplated that other time intervals, such as every minute, half hour, hour, 12 hours, day etc. may be used.

The bandwidth control settings 308 may specify bandwidth settings according to a particular schedule 312. The bandwidth setting schedule 312 may specify a bandwidth allocation amount for particular devices. For example, on Sunday and Monday between 0:00 and 6:00 am no bandwidth is allocated to the device. When no bandwidth is allocated to devices, any wireless connections to the devices may be placed in a low power or suspended state. The schedule 312 further indicates that the gateway should reserve or allocate 4 Mbps of bandwidth everyday of the week between 18:00 to 0:00 for the associated devices. If no specific bandwidth requirements are specified, a default setting for the gateway may be applied.

The configurations depicted in FIG. 3 may be specified in regard to individual devices, or for groups of devices. The specific format on how the settings are specified may vary from that depicted in FIG. 3. Further, the particular configurations may be associated with different gateway operation modes and may be applied to the gateway when or if the associated operation mode is activated.

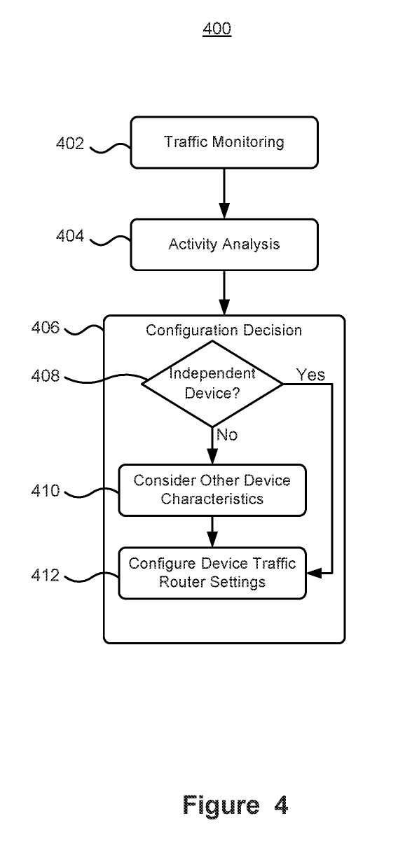

FIG. 4 depicts a method for automatically configuring WiFi gateway settings. The method 400 determines gateway settings for a device. The method 400 monitors network traffic (402). The monitoring of the traffic may log information associated with the network traffic to and/or from devices. The monitoring may ignore certain types of messages or network traffic that are not related to user activities, such as Internet Control Message Protocol (ICMP) messages. The logged information may include information on one or more of an amount of data sent or received, a time the data was sent/received at, a source and/or destination identifier, an application or application type identifier as well as other possible information. The monitored traffic may be analyzed (404) to determine activities associated with the traffic. The activity analysis may identify different activities that are associated with the traffic flows. For example, based on the traffic logs, certain traffic flows may be identified as being associated with streaming a movie or video, while other traffic flow may be associated with Internet browsing. The classified activities may be associated with the time of day, as well as the day, that the activity occurred.

Once the activities are determined, a configuration decision may be made (406). The configuration decision may determine if the device is identified as an independent device (408). Independent devices are devices whose configurations are only based on the determined activities of the device. Devices that are not independent devices are devices whose configuration may be based on activities of other devices as well. If the device is an independent device (Yes at 408), the method configures the device's traffic router settings based on the activity information (412). However, if the device is not an independent device (No at 408), the other devices' activity characteristics are considered (410) before configure the device traffic router settings (412).

As an example, for independent devices, the setting may use a usage model of the device indicating what activities are carried out when in order to configure the gateway to provide the activities. For non-independent devices, the setting may be based on providing activities for multiple devices. In order to provide bandwidth settings, even if all of the combined activities are associated with a greater amount of bandwidth than available, the activities and users may be associated with different priorities. Accordingly, one user's video streaming activities may be allocated a greater amount of bandwidth than another, lower priority user's similar video streaming activities.

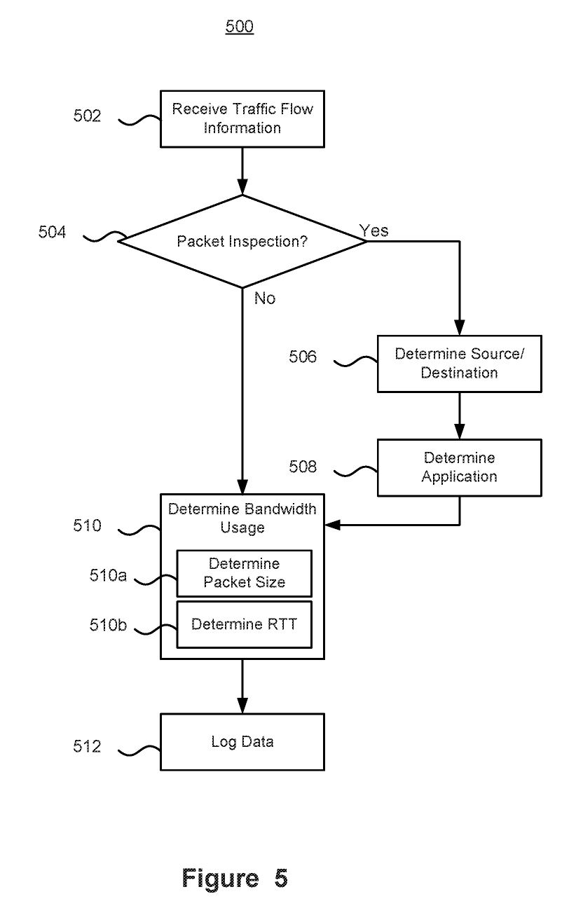

FIG. 5 depicts a method for monitoring WiFi gateway traffic. The method 500 receives traffic flow information (502) and if packet inspection is to be performed (Yes at 504) a source and/or destination of the traffic flow is determined (506). The application or application type associated with the traffic may be determined (508).

The bandwidth usage is determined (510), which may be based on various information associated with the traffic, such as a packet size (510a) and a round trip time (RTT) for each packet in the flow (510b). Once the information is determined, it is logged to a monitoring file (512). If packet inspection is not to be performed (No at 504), the bandwidth usage may be determined (510) and logged (512).

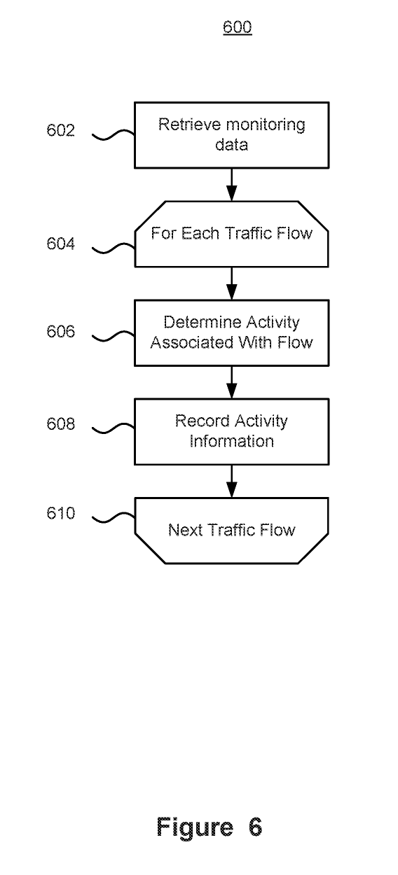

FIG. 6 depicts a method of analyzing the monitoring data. The method 600 analyzes the monitored traffic data in order to generate associated activity information. The method 600 retrieves monitoring data that has been logged (602) and for each of the traffic flows (604) within the monitored data, the method determines an activity associated with the flow (606). The activity determination may be made based on the available monitoring data, which may simply be an amount of bandwidth utilized at specific times or may also include information on the application used and or a source or destination of the traffic. Once the traffic is associated with an activity, the activity information may be recorded, along with a time the activity took place (608). The next traffic flow may be processed (610).

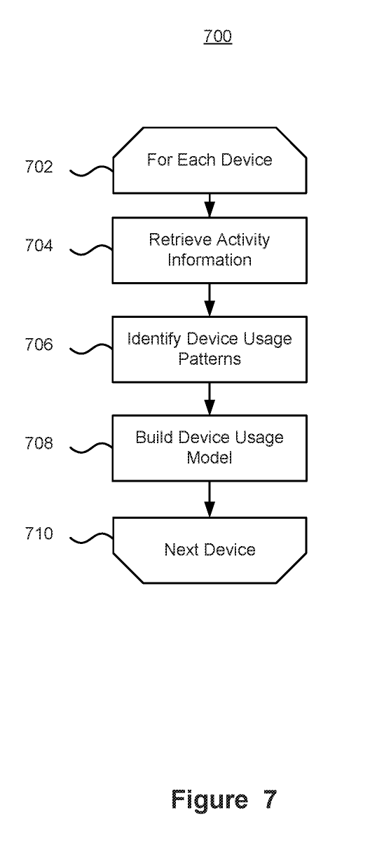

FIG. 7 depicts a method of processing device usage patterns. The method 700 processes process activity information for each device (702). The activity information for a device is retrieved (704) and the device usage patterns are determined from the activity information (706). The usage pattern may identify patterns of when activities take place, such as times when video are streamed, or other types of recurring activities. Once device usage patterns are identified a usage model of the device, which provides a model of activities for the device indicating when particular activities occur may be built and stored (708) and the next device is processed (710).

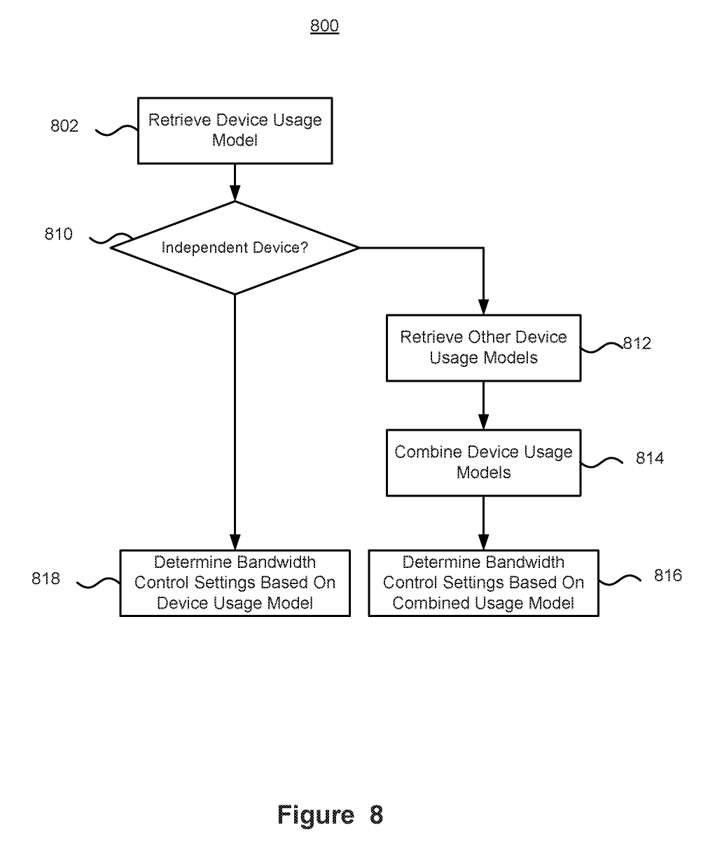

FIG. 8 depicts a method for determining WiFi gateway bandwidth settings. The method 800 generates bandwidth control settings. The method retrieves a device usage model (802) and if the device is not an independent device (No at 804) the device usage models of other devices are retrieved (806) and combined together into a combined usage model (808). The combined usage model may be used to determine bandwidth control settings based on the combined model (810). The model may indicate what activities are performed by what devices at particular times. The bandwidth control settings may be determined to provide the required bandwidth to the device in order to best satisfy all of the activities of the different devices. If the device is an independent device (Yes at 804) the bandwidth control settings may be determined based on the sole device usage model (812). Although not depicted in FIG. 8, once the bandwidth control settings are determined for one or more devices, they may be applied to the gateway in order to automatically configure the network access of the gateway.

The hardware, software, firmware and combinations thereof providing the above described functionality may reside in the same physical systems, or may be distributed in multiple devices and/or systems.

Although specific embodiments are described herein, it will be appreciated that modifications may be made to the embodiments without departing from the scope of the current teachings. Accordingly, the scope of the appended claims should not be limited by the specific embodiments set forth, but should be given the broadest interpretation consistent with the teachings of the description as a whole.

What is claimed is:

1. A wireless network gateway comprising:
a plurality of network interfaces for connecting to a plurality of communication devices;
routing functionality for routing network traffic between the network interfaces, the routing functionality including bandwidth control functionality for controlling network traffic associated with one or more of the connected communication devices;
monitoring functionality for logging traffic flow information associated with a plurality of the communication devices;
analysis functionality for processing logged traffic flow information to identify activities associated with the logged information; and
auto configuration functionality for setting bandwidth control characteristics based on identified activities.

2. The wireless network gateway of claim 1, wherein the bandwidth control characteristics specify an amount of bandwidth allocated to a particular one of the communication devices.

3. The wireless network gateway of claim 2, wherein the bandwidth control characteristics are associated with a device or group of devices and determined based on a sole communication device's determined activities or activities of communication devices associated with the device group.

4. The wireless network gateway of claim 1, wherein the auto configuration functionality further configures traffic filter settings for filtering network traffic of the device.

5. The wireless network gateway of claim 1, wherein the analysis functionality is at least partially performed at a network connected server.

6. The wireless network gateway of claim 1, wherein the logged information includes bandwidth usage information associated with a device or device group.

7. The wireless network gateway of claim 6, wherein the logged information further comprises one or more of application information, source information, and destination information.

8. The wireless network gateway of claim 1, wherein the bandwidth control characteristics are specified at scheduled times.

9. The wireless network gateway of claim 1, further comprising user interface functionality for providing an interface for interacting with the wireless network gateway.

10. The wireless network gateway of claim 1, wherein the plurality of communication devices are grouped together into a plurality of device groups.

11. A method for configuring wireless network gateway comprising a plurality of network interfaces for connecting to a plurality of communication devices, the method comprising:
routing network traffic between the network interfaces in accordance with bandwidth control functionality for controlling network traffic associated with one or more of the connected communication devices;
logging traffic flow information associated with a plurality of the communication devices;
processing logged traffic flow information to identify activities associated with the logged information; and
setting bandwidth control characteristics based on identified activities.

12. The method of claim 11, wherein the bandwidth control characteristics specify an amount of bandwidth allocated to a particular one of the communication devices.

13. The method of claim 12, wherein the bandwidth control characteristics are associated with a device or group of devices and determined based on a sole communication device's determined activities or activities of communication devices associated with the device group.

14. The method of claim 11, further comprising configuring traffic filter settings for filtering network traffic of the device.

15. The method of claim 11, wherein the processing of logged traffic flow information is at least partially performed at a network connected server.

16. The method of claim 11, wherein the logged information includes bandwidth usage information associated with a device or device group.

17. The method of claim 16, wherein the logged information further comprises one or more of application information, source information, and destination information.

18. The method of claim 11, wherein the bandwidth control characteristics are specified at scheduled times.

19. The method of claim 11, further comprising providing an interface for interacting with the wireless network gateway.

20. The method of claim 11, wherein the plurality of communication devices are grouped together into a plurality of device groups.
